(19) United States
(12) Patent Application Publication
(10) Pub. No.: US 2026/0237909 A1
(43) Pub. Date: Aug. 13, 2026

(54) ANTENNA DEVICE AND AIRCRAFT/SPACECRAFT

(71) Applicant: Universität der Bundeswehr München, Neubiberg (DE)

(72) Inventor: Stefan LINDENMEIER, Gauting-Buchendorf (DE)

(73) Assignee: Universität der Bundeswehr München, Neubiberg (DE)

(21) Appl. No.: 19/112,933

(22) PCT Filed: Sep. 21, 2023
(86) PCT No.: PCT/EP2023/076041

§ 371 Date: Mar. 18, 2025

(30) Foreign Application Priority Data
Sep. 24, 2022 (DE) 102022003521.9

(51) Int. Cl. H01Q 13/08; H01Q 1/28; H01Q 3/40; H01Q 15/02

(52) U.S. Cl. CPC H01Q 13/08; H01Q 1/288; H01Q 3/40; H01Q 15/02

(57) ABSTRACT

The invention concerns an antenna device (1) for transmission and reception of microwaves with controllable multi-beam directionality, comprising: a base body (2), which comprises at least one plate-shaped module (3) as a first type and at least one further plate-shaped module (4) as a second type, the first module(s) (3) and the second module(s) (4) being stacked on top of one another and their end faces (5-8) taken together defining side-surfaces (10-12) of the base body (2), wherein each module (3, 4) comprises at least one transmission side-surface (14, 16, 43) as an end face thereof (5-8), each transmission side-surface (14, 16, 43) of each module (3, 4) comprises a plurality of antenna elements (13), the first module(s) (3) and the second module(s) (4) are arranged such that one transmission side-surface (14, 43) of the first module(s) (3) is part of a first side-surface (9) of the base body (2) and one transmission side-surface (16, 43) of the second module(s) (4) is part of a second side-surface (10) of the base body (2), the first and second side-surfaces (9, 10) of the base body (2) being different, and each transmission side-surface (14, 16, 43) of each module (3, 4) defines, via its antenna elements (13), an antenna array. The present invention also concerns an aircraft or a spacecraft, especially a satellite (100), comprising the antenna device (1).

The invention concerns an antenna device for transmission and reception of microwaves with controllable multi-beam directionality. Furthermore, the invention concerns an aircraft or a spacecraft comprising said antenna device.

Especially in aircraft or spacecraft, antenna devices which can controllably receive and/or transmit in multiple directions (“multi-directional antennas”), especially in multiple directions simultaneously (“multi-beam”), are employed so as to receive and/or transmit signals, from/to for example a stationary base station, even when travelling by the opposing transmitter/receiver (i.e. the stationary base station for example). Conventionally, such multi-beam directional antenna devices are known, for example from U.S. Pat. No. 8,604,989 B1. Such antenna devices are known to comprise arrays of antenna elements as an integrated phased array with which power and/or directionality of beam transmission can be controlled. In the aforementioned example, the phased array antenna device comprises the array of antenna elements, a plurality of waveguides, a beam forming network, and an RF switch. By adjusting phase angles of signals received/transmitted from the antenna elements in the array, the device effectively steers an antenna beam.

However, the proposed solutions are bulky and heavy. Furthermore, their directionality range of transmittable/receivable beams is highly limited, especially to opposing transmitters/receivers facing the array of antenna elements.

It is an object of the present invention to provide an antenna device which can overcome these deficiencies. In particular, one of the objects of the present invention is to provide an antenna device which is compact, light, and has a large range of transmittable/receivable beam axes, and is thus particularly suited for applications in aircraft and/or spacecraft, for example satellites. Another object of the present invention is to provide an antenna device which has advantageous thermal properties, specifically advantageous thermal distribution throughout the device. Furthermore, it is an object of the present invention to provide an aircraft or spacecraft, especially a satellite, which comprises said antenna device and is thus compact, light, and capable of sending/receiving signals over a wide angle range.

These objects are solved by the subject matter of the independent claim. The dependent claims contain advantageous embodiments of the present invention.

In particular, these objects are solved by an antenna device for transmission and reception of microwaves with controllable multi-beam directionality according to the following. The antenna device comprises a base body. The base body comprises at least one plate-shaped module as a first type and at least one further plate-shaped module as a second type. The first module(s) and the second module(s), i.e. the module(s) of the first type and the second type, are stacked on top of one another. Their end faces, taken together, define side-surfaces of the base body. Therein, each module comprises at least one transmission side-surface as an end face thereof. Each transmission side-surface of each module comprises a plurality of antenna elements. The first module(s) and the second module(s) are arranged such that one transmission side-surface of the first module(s) is part of a first side-surface of the base body and one transmission side-surface of the second module(s) is part of a second side-surface of the base body, wherein the first and second side-surfaces of the base body are different. Furthermore, each transmission side surface of each module defines, via its antenna elements, an antenna array. In the foregoing and the following, “transmission side-surface(s)” are referred to for simplicity. As appreciated by the skilled person, an antenna element or array can principally transmit and receive, such that “transmission side-surface(s)” may also refer to “reception side-surface(s)”. Therefore, in the following for simplicity, only transmission may be referred to, without excluding reception unless specifically explained as such. Furthermore, as will be explained in higher detail below, the antenna device is not restricted to comprising modules of a first type and a second type. The antenna device may further comprise modules of a third type, a fourth type, etc. These further types may share, as respective transmission side-surface(s), side-surfaces of the base body with other module types, or each may be part of a different side-surface of the base body, as is the case with the first module(s) and the second module(s).

The invention of claim 1 thereby provides an antenna device which, via the antenna array of each module, provides controllable multi-beam directionality. Furthermore, by providing multiple, i.e. at least two, module types with their transmission side-surfaces defining different (at least first and second) side-surfaces of the base body, the range of transmission/reception of the device is enhanced. In this regard, the term “the first and second side-surfaces of the base body being different” implies that the first and second side-surfaces of the base body face different directions. Thereby, one (for example the first) side-surfaces can transmit to or receive from a range of angles different from another (for example the second) side-surface of the base body, such that the range of transmittable/receivable angles is greatly enhanced. Furthermore, since the modules are stacked on top of each other, enhanced heat distribution is achieved between them, thereby reducing signal noise.

In some embodiments, the first module comprises one transmission side-surface as an end face thereof, especially exactly one transmission side-surface as an end face thereof. Further, the second module preferably comprises one transmission side-surface as an end face thereof, especially exactly one transmission side-surface as an end face thereof. This may also be the case for third or more type of modules. In other words, each module preferably comprises exactly one transmission side-surface. As elucidated further below and throughout the embodiments, in some embodiments, one or more or all of the modules (of one or more types) respectively comprises more than one transmission side-surface. For example, one or more or all of the modules respectively comprise two transmission side-surfaces. Providing exactly one transmission side-surface as explained above has the advantage in that each of the modules is easy to manufacture and requires low complication of control. Providing more than one, especially two, transmission side-surfaces as explained above has the advantage in that a scope of possible angles for transmission/reception can be improved.

In some embodiments, the first and second module(s) are arranged such that their transmission side-surfaces provide beam ranges which do not overlap with one another, i.e. such that beam ranges provided by the first module(s) do not overlap with those provided by the second module(s). For example, in some embodiments, the first module(s) and second module(s) are arranged such that the first side-surface of the base body essentially opposes the second side-surface of the base body.

Alternatively to the aforementioned non-overlapping transmission side-surfaces of the modules, the modules may comprise common transmission side-surfaces in addition to the transmission side-surfaces defining different side-surfaces of the base body. For example, a first module type may comprise two transmission side-surfaces (a first and a second transmission side-surface), and a second module type may comprise two transmission side-surfaces, wherein these are respectively different end faces of each module. Therein, a first transmission side-surface of the first module type, as explained above, defines a different (i.e. aforementioned first side-surface of the base body) side-surface of the base body than a first transmission side-surface of the second module type (i.e. aforementioned second side-surface of the base body). In addition thereto, the second transmission side-surface of the first module type and the second transmission side-surface of the second module type may define in common (i.e. be a part of) a same side-surface of the base body, for example a third side-surface of the base body.

In some advantageous embodiments, a plurality of the antenna elements of each module are arranged in a line. Thereby, these antenna elements define or are arranged in a row of antenna elements. In an exemplary case in which at least two of at least one single type of module are provided, thereby formed columns of antenna elements provide an antenna matrix array. For example, in an exemplary case in which one first module and two second modules are provided, the antenna elements of the first module (forming the first side-surface of the base body) define a row of antenna elements, i.e. a linear array of antenna elements. Further, the antenna elements of the two second modules (forming the second side-surface of the base body different from the first side-surface of the base body) define two rows of antenna elements, which taken together form a matrix array (two columns, number of rows corresponding to number of antenna elements in linear array). This can be expanded to also multiple first modules and/or further types of modules. In examples in which each module comprises more than one transmission side-surface, the foregoing explanation is to be understood with respect to each separate transmission side-surface.

Advantageously, each module further comprises a coupling side-surface as another end face thereof. Therein, each coupling side-surface of each module comprises a plurality of coupling ports. In other words, each module comprises a coupling side-surface different from its transmission side-surface(s). The coupling ports of the coupling side-surface provide coupling to/from the module of a signal to be transmitted or received from the module.

Preferably, the modules are arranged such that the coupling side-surfaces of all modules are part of a same third side-surface of the base body. In other words, the module types (i.e. at least the first type and the second type) are arranged such that their transmission side-surfaces define different side-surfaces of the base body and such that their coupling side-surfaces define the same side-surface of the base body. For example with each module having one transmission side-surface, the transmission side-surface of the first module(s) is part of a first side-surface of the base body, the transmission side-surface of the second module(s) is part of a second side-surface of the base body, and the coupling side-surfaces of the first module(s) and the second module(s) are, taken together, part of a third side-surface of the base body. In particular, the coupling side-surface is different from the side-surfaces of the base body defined by the transmission side-surfaces of the modules. By providing a common coupling side-surface between the different module types, the configuration of the antenna device may be made more compact, and a feed of signals to/from the coupling ports is simplified, since it may be provided to/from a single side-surface of the base body.

In some examples, (one or more) end face(s) of one type of module(s) which does/do not comprise any antenna elements, i.e. a non-transmission side-surface thereof, and (one or more) end face(s) of a different type of module(s) which does/do comprise antenna elements, i.e. a transmission side-surface thereof, together form a common side-surface of the base body.

Preferably, the end faces of the modules define planar side-surfaces of the base body. In other words, the modules are preferably of the same size and are aligned so as to form flat, planar side-surfaces of the base body (apart from antenna elements and/or hollow waveguides explained below).

In some advantageous embodiments, each module comprises a plurality of hollow waveguides. The hollow waveguides connect the coupling side-surface with the transmission side-surface, and especially connect the coupling ports with the antenna elements. The hollow waveguides are formed within the respective modules. Since hollow waveguides are provided, the configuration of the antenna device may be made more compact.

The antenna elements may be formed as open ends of the hollow waveguides or as a cover circuit board in addition to the shown open ends of the hollow waveguides.

In particular, the modules comprise or consist primarily of a material which is non-transparent for the microwaves to be transmitted/received thereby. Preferably, the material comprises or consists of a metal, for example aluminum. This has the advantage that heat distribution within and between the individual modules is increased, which further increases efficiency and lowers a negative effect of temperature on wavelength or wave direction. The hollow waveguides are preferably formed as hollowed-out elongated portions of the modules, connecting the antenna elements and the coupling ports, i.e. connecting the transmission side-surface with the coupling side-surface. Further preferably, the modules are each formed of two plates as a composite panel, wherein each of the plates comprises respectively grooves formed therein which provide half (in thickness perpendicular to beam propagation direction) of the hollow waveguides. Further preferably, two modules are formed by three plates as a composite panel, wherein two outer plates sandwich an inner plate, the inner plate comprising on both sides (facing the outer plates) one half of the hollowed portions, and each outer plate respectively comprising the other half of the hollowed portions.

In some advantageous embodiments, each module comprises a beam-forming network connected to the hollow waveguides. Therein, the beam-forming network of each module comprises at least one of a Ruze lens, a Rotman lens, a Luneberg lens, and a Butler matrix. In other words, the beam-forming network of each module comprises one or more of the foregoing elements. In particularly advantageous embodiments, the beam-forming network of each module comprises a Rotman lens.

Preferably, in the case of one or modules comprises two or more transmission side surfaces, the respective beam-forming network comprises correspondingly multiples of the Ruze lens, Rotman lens, Luneberg lens, or Butler matrix. In addition or alternatively thereto, one or more modules with two or more transmission side surfaces comprises one of the foregoing described elements and at least one hollow waveguide connected directly to the antenna elements of the second transmission side surface, which is different from the transmission side surface to which the foregoing described element(s) are connected to.

Further preferably, the beam-forming network is formed as hollowed-out portions of the modules, especially similar to the hollow waveguides. For example, the modules being formed of composite panels, each of the plates may comprise grooves forming a respective half or share of the beam-forming network. For example, a Rotman lens may be formed by two opposing elliptically hollowed-out portions of the composite panel.

Advantageously, an electric path length of at least two hollow waveguides between the coupling side-surface and the transmission side-surface differs between one another. Thereby, phase differences or path length differences introduced by a curvature of an element of the beam-forming network, especially a Rotman lens, is corrected between the two hollow waveguides of different electric path lengths. In an example of a Rotman lens, such hollow waveguides with different electric path lengths are also commonly referred to as “phase correction lines”. Thereby, the beam can be scanned along a wide range of transmission/reception angles via the beam-forming network.

In some examples, the antenna device further comprises a signal distribution network, wherein the signal distribution network comprises a plurality of network ports. Each of the network ports is connected to one coupling port. In other words, the network ports couple the signal distribution network to the coupling side-surface of each module, i.e. its coupling ports, so as to feed/receive signal to/from the module.

Preferably, the signal distribution network comprises at least one switch element respectively configured to switch at least one, especially exactly one, network port. Thereby, the signal distribution network selectively couples with the coupling ports of each module via its network ports and the at least one switch. In the case of one switch switching a plurality of network ports, different coupling ports of one or different modules may be switched simultaneously.

In one advantageous embodiment, the signal distribution network comprises a bidirectional front end. The bidirectional frontend is connected to the network ports and is configured to phase-shift, especially variably phase-shift, a signal between the network ports so as to control beam directionality and especially beam sectioning of transmitted/received (receivable) microwaves.

In particular, the bidirectional frontend (henceforth “frontend”) is connected to all coupling ports of a single module in common via a single frontend-line and via the network ports of the signal distribution network. Each of the coupling ports is connected to the frontend via one respective switch connected to the frontend-line such that the number of switches, per module, corresponds to the number of coupling ports/network ports. Therefore, the signal distribution network comprises a number of frontend-lines corresponding to the total number of modules (of all types), each one frontend-line being connected to one module. By introducing a phase-shift between the different modules (i.e. between different frontend-lines), the modules can be controlled to form beams separate from one another or controlled so as to taken together form a common beam via interference.

In some preferable embodiments, the number of coupling ports and the number of antenna elements are not equal. In other words, the number of coupling ports does not correspond to the number of antenna elements. For example, in the case of each module comprising a Rotman lens, the number of coupling ports may be higher than the number of antenna elements.

Advantageously, for prevention of coupling a shortest distance between two antenna elements of one module and/or between two antenna elements of multiple modules of the same type is not substantially less than λ/2 and for prevention of grating lobes a largest distance between two antenna elements of one module and/or between two antenna elements of multiple modules of the same type is not substantially more than λ/2. Preferably, the aforementioned distance is ideally 0.5 λ. In some cases, the aforementioned distance is between 0.4 λ and 0.8 λ, preferably in increments of 0.1 λ. Therein, λ refers to a wavelength of transmitted/received signal. Especially when considering a range of wavelengths for transmission/reception of signals, for instance a Ka frequency band (26.5 GHz-40 GHz), A with respect to the shortest distance is predetermined as a median value or an arithmetic mean of the range. Preferably, the term “substantially” refers to an exact distance with additional manufacturing tolerances, of for example 10% or 5%. For example, two neighboring and adjacent antenna elements in a row of one module (for example, a module of the first type) are spaced apart from one another by λ/2. Further, for example, one antenna element of one module of the first type is spaced apart from a corresponding antenna element (of the same row) of a second module of the first type (both on same side-surface) by λ/2. Thereby, antenna elements of the same and/or separate modules may interfere with one another, thus allowing common beam formation from different antenna elements of different or same modules of the same type.

In some advantageous embodiments, the antenna device further comprises at least one further plate-shaped module as a third or more type. Therein, each type of module comprises a respective transmission side-surface. Furthermore, all types of modules are arranged such that their transmission side-surfaces are part of different side-surfaces of the base body. In other words, the base body comprises a number of side-surfaces at least corresponding to the number of module types. In combination with coupling side-surfaces thereof defining the same side-surface, such a base body comprises a number of side-surfaces corresponding to the number of module types plus one. For example, comprising three module types, the base body in such a combination example would comprise four side-surfaces, namely three side-surfaces corresponding to the different transmission side-surface of the three module types and one side-surface corresponding to the coupling side-surface of all three module types (in common).

Advantageously, the modules of all types are arranged alternating in periodical fashion by their types. For example, along a stacking direction: One first module, one second module, one third module, one first module, one second module, one third module, etc. Alternatively, multiple modules of the same type may be stacked directly on top of one another within this periodic arrangement, for example: two first modules, two second modules, two third modules, etc. The alternating arrangement has the advantage that the total height or volume of the antenna device can be reduced, especially since a module of a first type can be sandwiched between two modules of second or third types while maintaining wavelength requirements for distances between antenna elements of each of the modules (first to first modules or first to other modules).

Preferably, the antenna device further comprises or is connected to a processing means for processing transmitted and/or received signals. The processing means is, for example, a CPU, GPU, FPGA, ASIC, etc.

The antenna device, especially the frontend thereof, preferably further comprises signal processing means such as one or more bandpass filters, phase-shift circuits, and/or converter circuits.

Preferably, the signal distribution network is printed at least partially on a circuit board. Preferably, the signal distribution network, especially the printed circuit board thereof, is disposed on a base plate supporting the base body of the antenna device.

The present invention also concerns an aircraft or a spacecraft, particularly a satellite, which comprises at least one antenna device according to the foregoing embodiments and examples. For example, if the antenna device of the exemplary satellite comprises two module types, and their transmission side-surfaces define first and second side-surfaces of the base body opposing one another in flight direction, one transmission side-surface can communicate with a stationary base station while travelling towards said station, whereas the other transmission side-surface can communicate with said station while travelling away from said station. Of course, this can be carried out simultaneously, especially with multiple base stations. If the antenna device for example comprises a third module type, the satellite can communicate with the base station also in case it travels directly above said base station.

Thereby, the present invention provides a compact, lightweight antenna device with a high range of transmittable/receivable beams and advantageous thermal distribution as well as an aircraft or spacecraft with these advantages.

Further details, advantages, and features of the preferred embodiments of the present invention are described in detail with reference to the figures. Therein:

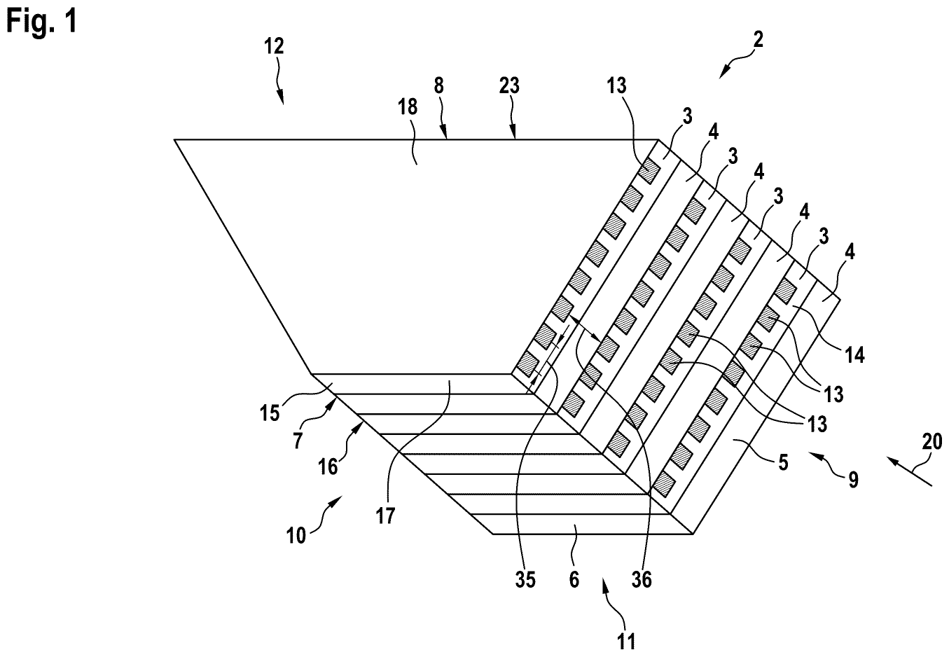

FIG. 1 shows a perspective view of modules comprised in an antenna device according to a first embodiment of the present invention;

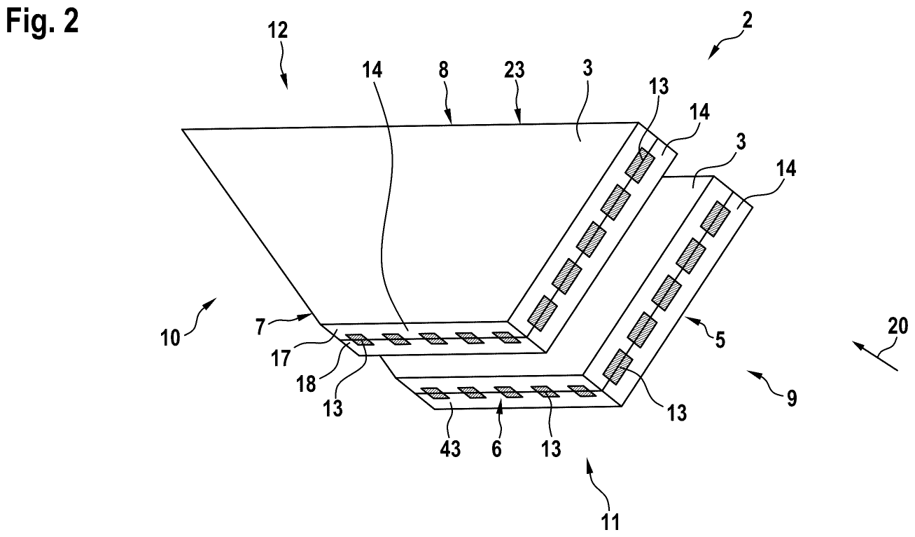

FIG. 2 shows a perspective explosion view of modules comprised in an antenna device according to a second embodiment of the present invention;

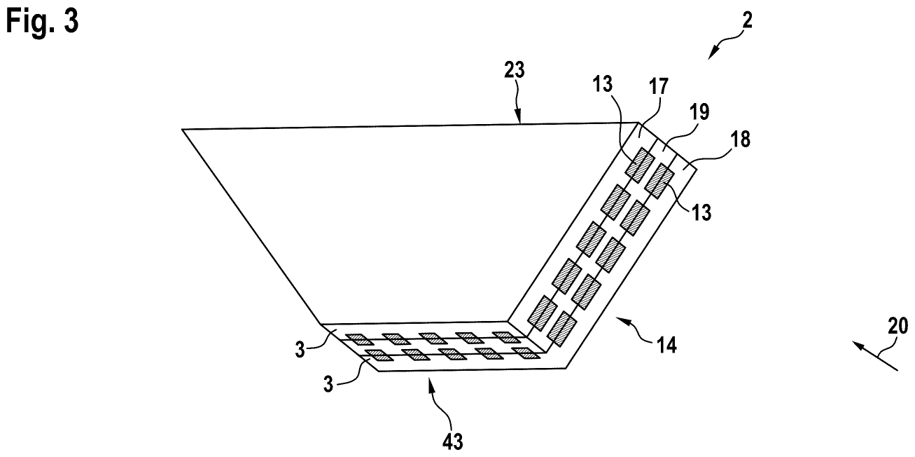

FIG. 3 shows a perspective view of modules comprised in an antenna device according to a third embodiment of the present invention;

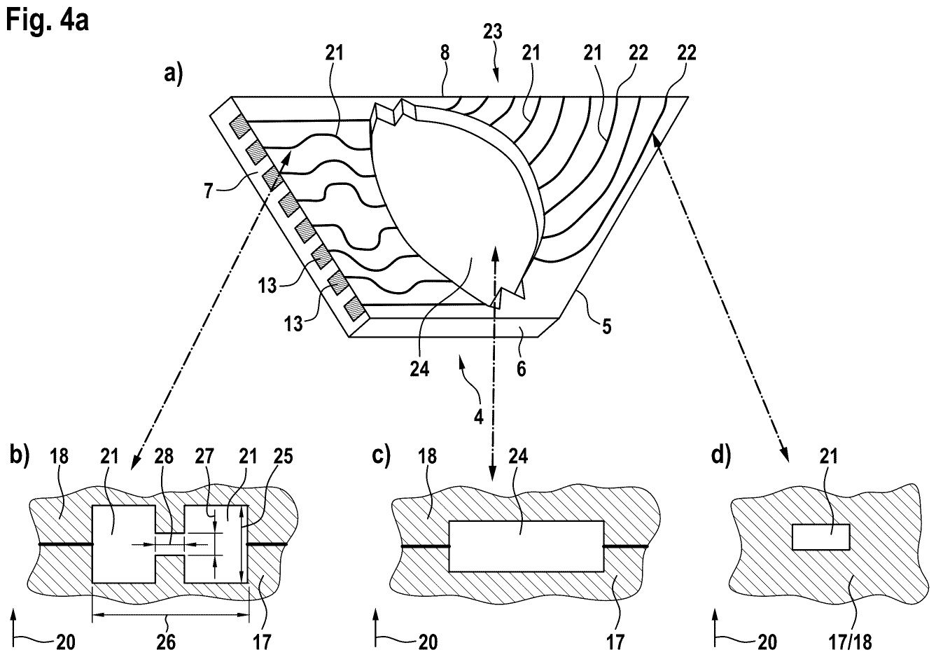

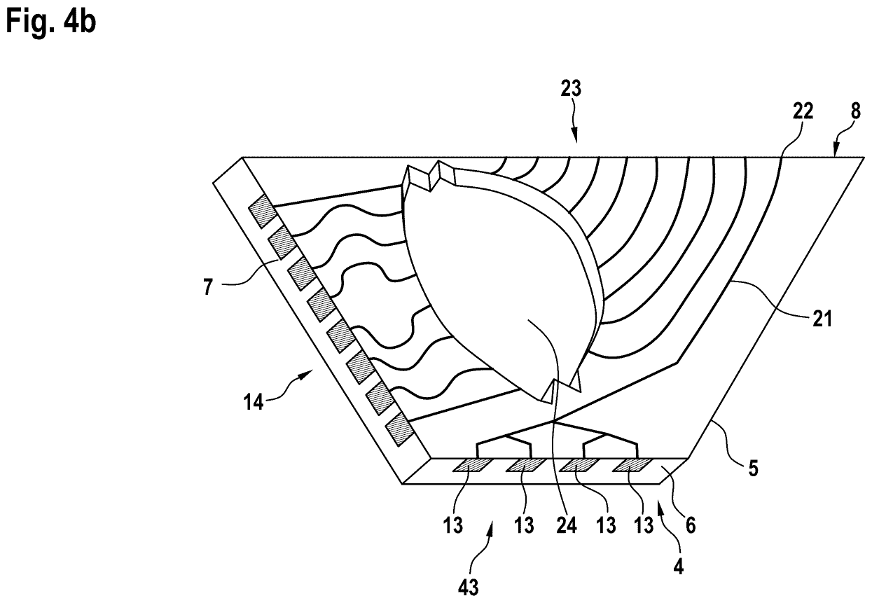

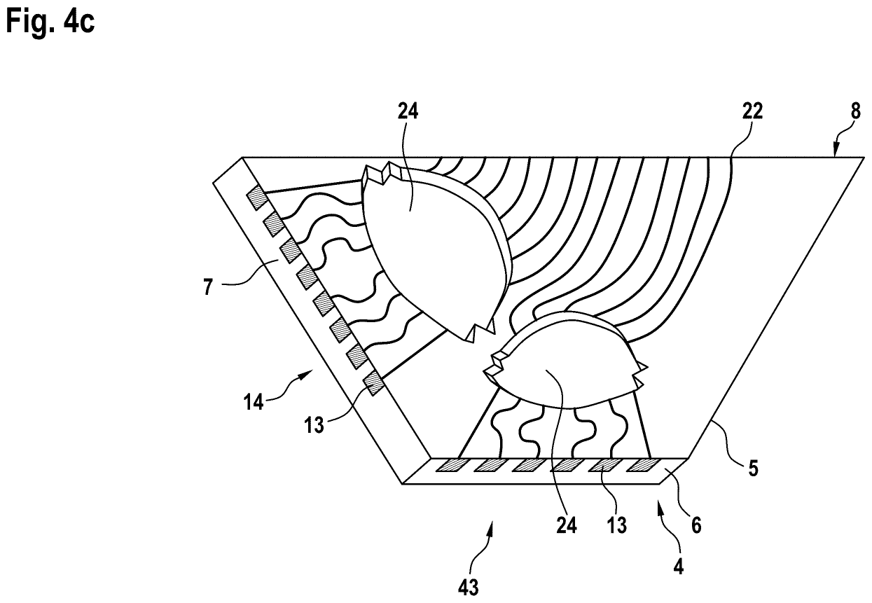

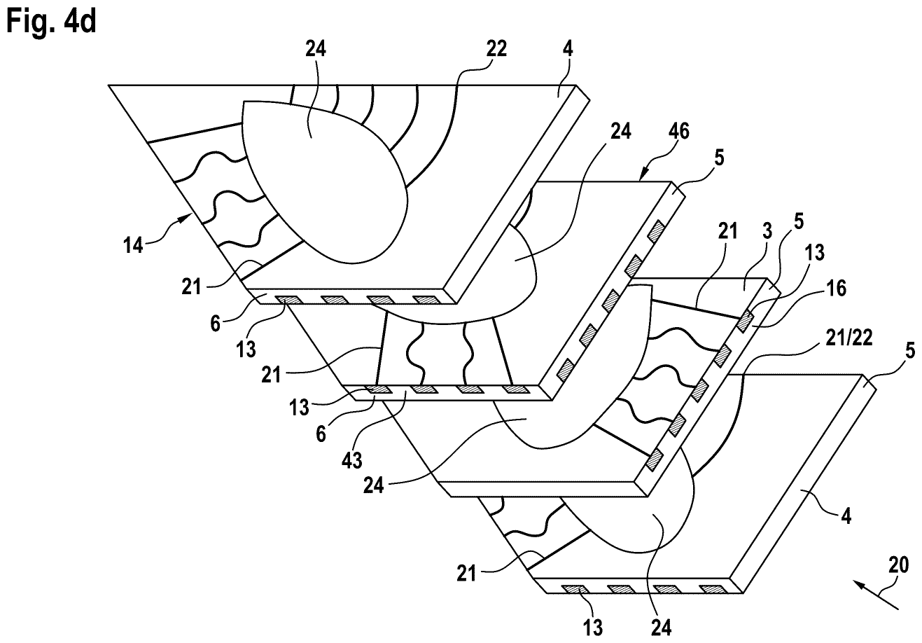

FIG. 4a shows a detailed cross-sectional view of one module comprised in an antenna device according to the first embodiment of the present invention;

FIG. 4b shows a detailed cross-sectional view of one module comprised in an antenna device according to the second or third embodiment of the present invention;

FIG. 4c shows a detailed cross-sectional view of an alternative example of one module comprised in an antenna device according to the second or third embodiment of the present invention;

FIG. 4d shows a detailed cross-sectional view of another alternative example of multiple modules comprised in an antenna device according to the second or third embodiment of the present invention;

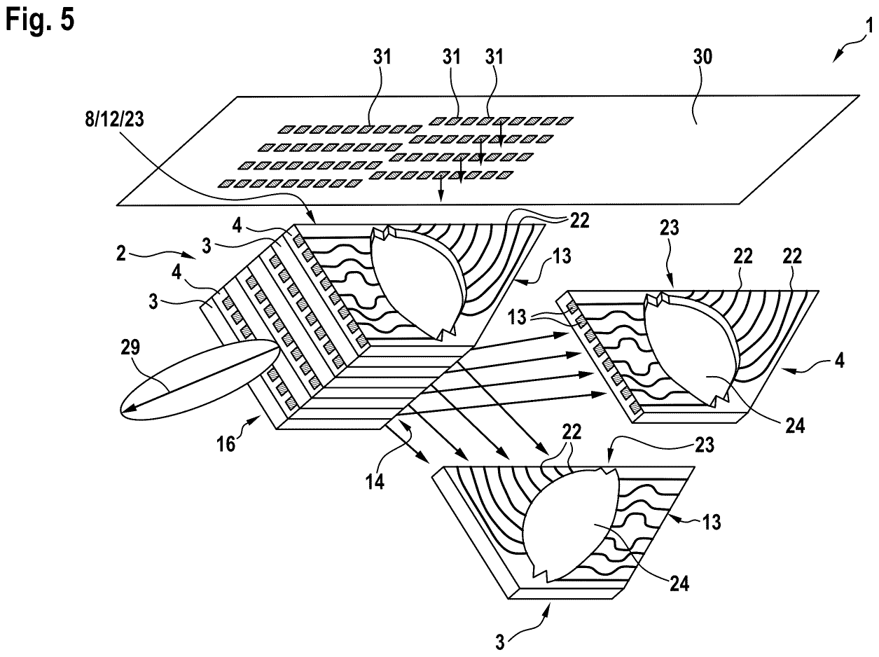

FIG. 5 shows a schematic diagram displaying components of the antenna device according to the first embodiment of the present invention;

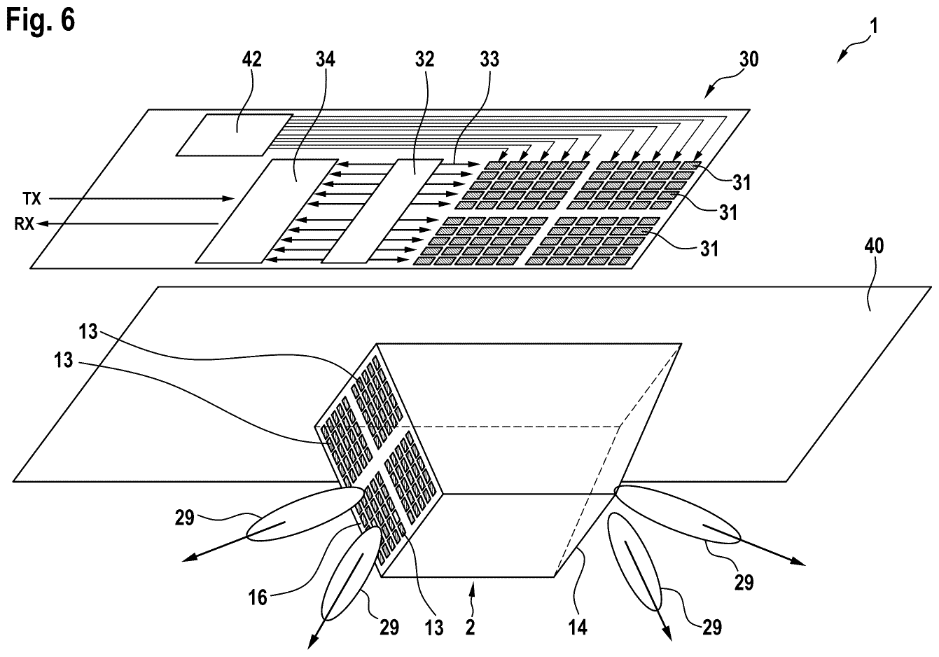

FIG. 6 shows a perspective view of details of the antenna device according to the first embodiment of the present invention;

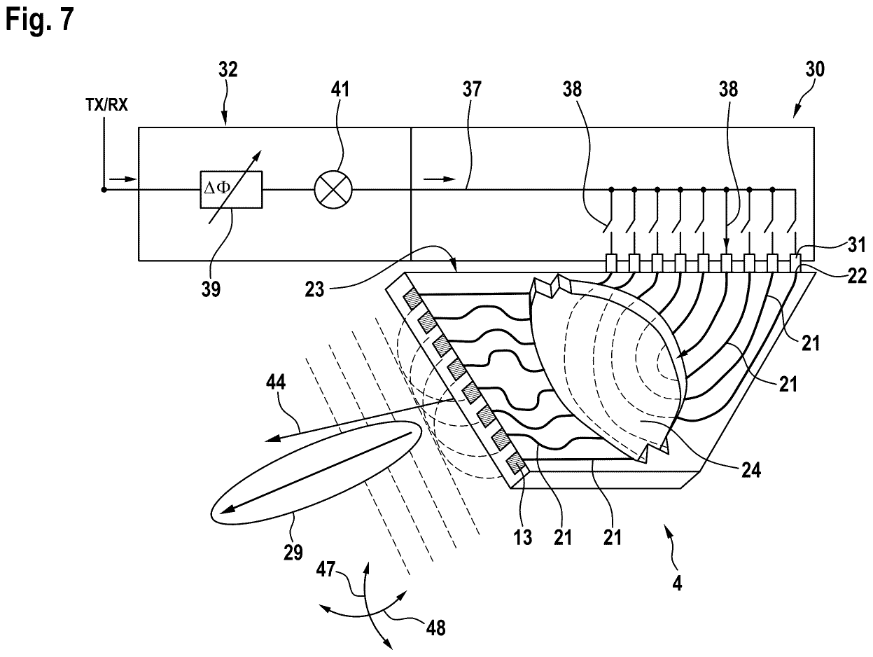

FIG. 7 shows a detailed view of a part of the antenna device according to the first embodiment of the present invention shown in FIG. 6; and

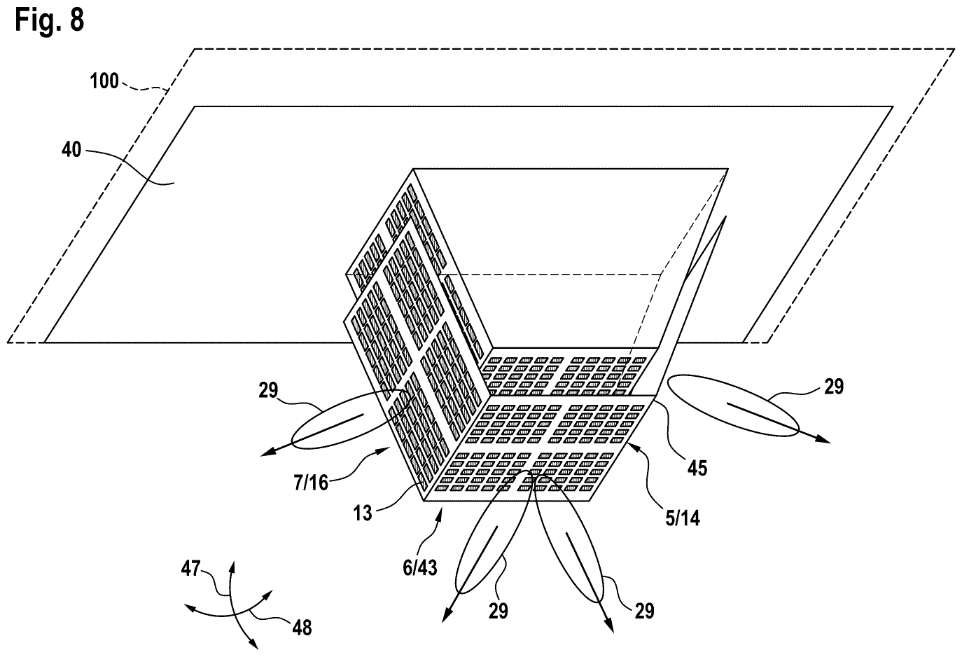

FIG. 8 shows a schematic diagram of the antenna device according to the second or third embodiment of the present invention.

FIG. 1 shows a perspective view of modules 3,4 comprised in an antenna device 1 according to a first embodiment of the present invention.

The antenna device 1 is for transmission and reception of microwaves with controllable multi-beam directionality. In the following, an arrangement and configuration of modules 3, 4 and a base body 2 of the antenna device 1 will first be explained, before functioning of the antenna device 1 is explained.

In particular, FIG. 1 shows the base body 2 of the antenna device 1 according to the first embodiment.

The base body 2 is formed of multiple modules 3, 4. In particular, the base body 2 is defined as the totality of all modules 3, 4. As can be seen in FIG. 1, the base body 2 of the present example has a blunted pyramid shape. The modules 3, 4 are plate-shaped in the shape of a blunted pyramid shape, and are stacked on top of one another to form the base body 2.

As can be seen in FIG. 1, the base body 2 comprises modules 3 of a first type (henceforth “first modules”) and modules 4 of a second type (henceforth “second modules”). The modules 3, 4 of both types each comprise four end faces, namely (clockwise in FIG. 1) a first end face 5, a second end face 6, a third end face 7, and a fourth end face 8.

Each of the modules 3, 4 comprises antenna elements 13. These antenna elements 13 are arranged, per module 3, 4, in a row on one of the end faces 5, 7. Due to the perspective view of FIG. 1, only the antenna elements 13 of the first modules 3 are shown. With respect to the first modules 3, the antenna elements 13 are arranged on one end face, namely the first end face 5 thereof. This end face 5, via the antenna elements 13, thereby defines a transmission side-surface 14 of the first modules 3. For reference, in the present embodiment, the other visible end face, namely the second end face 6 of the first modules 3 does not comprise antenna elements 13, and thus may be defined as forming a non-transmission side-surface 15 of the first modules 3.

The second modules 4, although not visible, also comprise antenna elements 13 in rows, especially in the same manner as the first modules 3. Thereby, each of the second modules 4 also comprises a transmission side-surface 16. The transmission side-surfaces 16 of the second modules 4 are formed on their third end faces 7. For example, the second modules 4 may essentially be flipped first modules 3. Furthermore, the second end face 6 of the second modules 4 is also defined as a non-transmission side-surface 15 of the second modules 4 in the present embodiment.

Herein, the first modules 3 and the second modules 4 are arranged such that the transmission side-surface 14 of the first modules 3 is part of a first side-surface 9 of the base body 2. Further, the transmission side-surface 16 of the second modules 4 is part of a second side-surface 10 of the base body 2. The first side-surface 9 and the second side-surface 10 of the base body 2 are different side-surfaces 9, 10 of the base body 2. In particular, the first side-surface 9 and the second side-surface 10 oppose each other.

Each transmission side-surface 14, 16 thereby defines, via its antenna elements 13, an antenna array. Herein, each module 3, 4, especially each transmission side-surface 14, 16 of each module 3, 4, defines one linear antenna array.

Furthermore, as shown in FIG. 1, multiple first modules 3 and multiple second modules 4 are stacked alternatingly along a stacking direction 20, i.e. a first module 3, a second module 4, a first module 3, etc. Taken together, all first modules 3 thereby define an antenna matrix array (multiple stacked linear arrays) and all second modules 4 thereby define a further antenna matrix array. In particular, a shortest distance 35 between two adjacent antenna elements 13 of a single module 3 is substantially λ/2, λ being the wavelength of transmitted/received signal or a median value or an arithmetic mean of a range of wavelengths transmitted/received by the antenna device 1. Preferably, a shortest distance 36 between two adjacent antenna elements 13 of two different modules 3 of the same type (for example of two first modules 3) is also substantially λ/2.

In general, the antenna device 1 may comprise more than first and second module types 3, 4. For instance, although not shown in FIG. 1 (compare FIG. 4d and FIG. 8; reference numeral 46), the antenna device 1 may especially comprise a third module type. This third module type preferably has its transmission side-surface 43 (shown in FIG. 8) on the second end face 6. Further, such first to third modules 3, 4 are stacked preferably alternating periodically, for example: First module 3, second module 4, third module, first module 3, second module 4, third module, etc.

As will be explained in greater detail below, each of the modules 3, 4 comprises, in the present embodiment, composite plates 17, 18, formed preferably of metal, particularly aluminum. The antenna elements 13 are for example ends of hollow waveguides, which will be explained below, open to the outside of each module 3, 4.

By providing such a configuration of first and second modules 3, 4 of the antenna device 1 with multiple different transmission side-surfaces 14, 16, the antenna device 1 has the advantage of a greater range of transmittable and/or receivable beams. Furthermore, the stacking of the modules 3, 4 allows for advantageous heat distribution between the modules 3, 4.

With reference to FIG. 2, a second embodiment of the modules 3, 4 will be explained. FIG. 2 shows a perspective explosion view of modules 3 comprised in an antenna device 1 according to a second embodiment of the present invention. In particular, for simplicity, FIG. 2 shows two of only one type of module 3, namely for example the first module 3 modified with respect to the first embodiment shown in FIG. 1. Herein, the base body 2 comprises similar to FIG. 1 a plurality of first modules 3 and a plurality of second modules 4, wherein for simplicity only the first modules 3 are shown.

Each first module 3 comprises antenna elements 13 on two end faces, namely the first end face 5 and the second end face 6. Although not shown, the second modules 4 comprise antenna elements 13 on their third end faces 7 (as described above with regard to FIG. 1), and also on their second end face 6 (see also FIGS. 4b, 4c, and 4d).

Thereby, each module 3 comprises two transmission side-surfaces 14, 43 with one of the transmission side-surfaces 43 from all modules 3, 4 (second modules 4 not shown) being a part of the same side-surface 11 of the base body 2, namely a fourth side-surface 11 of the base body 2. The first side-surface 9 of the base body 2 comprises the transmission side-surface 14 of only the first modules 3, the second side-surface 10 of the base body 2 comprises the transmission side-surface 16 of only the second modules 4 (see FIG. 1), and the fourth side-surface 11 of the base body 2 comprises the transmission side-surface 43 of both the first and the second modules 3, 4.

Furthermore, as shown in FIG. 2, each of the modules 3, 4 comprises two plates 17, 18. Each of the plates 17, 18 defines, in a thickness direction 20 (or stacking direction 20 of the modules 3, 4) one half of antenna elements 13, i.e. the ends of the hollow waveguides, as will be explained below.

Now, with reference to FIG. 3 a further third embodiment of the modules 3, 4 will be explained. FIG. 3 shows a perspective view of modules 3 comprised in an antenna device 1 according to a third embodiment of the present invention.

With regard to FIG. 1, it was explained that the modules 3, 4 may be stacked alternatingly and periodical (first module 3, second module 4, first module 3, etc. or first module 3, second module 4, third module, first module, second module, third module, etc). In general, as shown in FIG. 3, multiple modules 3 of a single type (in this case, first modules 3) may be stacked together. As shown in FIG. 3, two first modules 3 are stacked on top of each other.

In this regard, in combination with FIG. 1 or FIG. 2 (see also FIG. 8), the multiple stacked first modules 3 are further stacked periodically with the other modules, i.e.: two or more first modules 3, two or more second modules 4, two or more first modules 3, etc. or two or more first modules 3, two or more second modules 4, two or more third modules, two or more first modules 3, etc.

In the present embodiment, the two first modules 3 are formed together from three composite plates 17, 18, 19. Therein, two outer of the plates 17, 18 sandwich an inner of the plates 19. Each side of the inner of the plates 19 facing the outer of the plates 17, 18 defines, via hollowed portions, one half of the module with its antenna elements 13. The other halves of the module and its antenna elements 13 are respectively defined by one of the outer of the plates 17, 18.

The same technique of realization can be applied to the other embodiments of the present invention. This particularly enables easy production via treatment of the surfaces of metal plates. Thereby, the configuration of the antenna device 1 can be made more compact. This is because within the required distance of □□2 between neighbored antenna elements 13 of the same group of modules 3, further plates can be inserted which contain modules 4 of the other group. This way, the modules 3 and 4 of different groups share the same plates and hence more modules can be placed along the thickness/stacking direction 20.

Now, with reference to FIG. 4a, a detailed explanation of a configuration of one of the aforementioned modules 3, 4 of the first embodiment shown in FIG. 1 will be given. Therein, FIG. 4a shows a detailed cross-sectional view of one module 4 comprised in an antenna device 1 according to the first embodiment of the present invention. Although in the following the second module 4 will be referred to, the following explanation may also apply to a module of a first type or a third type, etc.

As can be taken from the cross-section of the module 4 in the inlet a) in FIG. 4a, each module 4 comprises a plurality of hollow waveguides 21. The waveguides 21 connect the antenna elements 13 with coupling ports 22 of the module 3. The coupling ports 22 are provided on a coupling side-surface 23 of each module 3. The coupling side-surface 23 is provided on an end face 8 which is different from the end face 7 on which the antenna elements 13 are provided (i.e. different from the transmission side-surface 16). The coupling side-surface 23, in particular the coupling ports 22, are for coupling in/out a signal to be transmitted/received by the antenna elements 13.

Further, the module 4 comprises a Rotman lens 24. The Rotman lens 24 is an example of a beam-forming network comprised by the modules 3, 4. Instead of the Rotman lens 24, one or more modules may additionally or alternatively comprise a Ruze lens, a Luneberg lens or a Butler matrix for beam-forming.

The Rotman lens 24 is connected to the coupling ports 22 via hollow waveguides 21. Further, the Rotman lens 24 is connected to the antenna elements 13 via hollow waveguides 21, wherein the antenna elements 13 are essentially open ends of the hollow waveguides 21.

The antenna elements 13 may be formed as the shown open ends of the hollow waveguides 21 or as a cover circuit board 45 (see FIG. 8) in addition to the shown open ends of the hollow waveguides 21.

The hollow waveguides 21 and the Rotman lens 24, as demonstrated by the inlets b), c), and d) of FIG. 4a, are formed as hollowed-out portions of the aforementioned plates 17, 18. In particular, each of the plates 17, 18 comprises, via its hollowed-out portions, one half or a share of each of the waveguides 21 and the Rotman lens 24, so that the stacking of the aforementioned plates forms a complete waveguide 21 and Rotman lens 24.

As shown in the inlet b) of FIG. 4a, the hollow waveguides 21, between the Rotman lens 24 and the antenna elements 13, are for example formed as a double ridged hollow waveguides 21, especially pair-wise. In alternative modifications, the hollow waveguides 21 may be formed as single ridged or without ridges.

In this example of the double ridged hollow waveguide 21, especially for carrying waves of a Ka frequency band (26.5 GHz-40 GHz), a height 25 is 3 mm, a total width 26 is 6.5 mm, a ridge-height 27 is 1.3 mm, and a ridge-width 28 is 1.7 mm.

The hollow waveguides 21 between the Rotman lens 24 and the coupling ports 22 are formed as rectangular waveguides 21, and as shown in the inlet d) of FIG. 4a, are preferably formed within one single plate 17, 18.

As can be seen in inlet a) of FIG. 4a, electric lengths of the hollow waveguides 21 differ between one another. In particular, the electric lengths of the hollow waveguides 21 are configured to as to negate a curvature of the Rotman lens 24 with respect to a phase-shift of the signal. Thereby, controlling for example which coupling port 22 receives (input) of the signal, the wave propagates due to the curvature of the Rotman 24 to the different hollow waveguides 21 at different time delays (different propagation lengths, i.e. phases) such that a direction of the wave can be controlled.

FIG. 4b shows a detailed cross-sectional view of one module 4 comprised in an antenna device 1 according to the second or third embodiment of the present invention (see also FIG. 2). As explained above with regard to FIG. 2, each module 3, 4 may comprise two transmission side surfaces 14, 43. This will now be explained, especially with reference to FIGS. 4b, 4c, and 4d.

In the present example of the module 4, the module 4 comprises the aforementioned Rotman lens 24 for one transmission side surface 14. Further, for the other transmission side surface 43, the module 4 comprises an additional coupling port 22 and an additional hollow waveguide 21, which is connected to the antenna elements 13 of the second end face 6. Thereby, the module 4 also transmits/receives via the other transmission side surface 43. This is especially advantageous for instances in which the antenna device 1 is directly above a base station. Furthermore, the input/output signal of the two transmission side surfaces 14, 43 can be combined to achieve more beam directions.

The examples of FIGS. 4b and 4c are preferably applicable also to the first modules 3. It should be noted however that not all modules need to comprise the other transmission side surface 43. For instance, only some (or all) first modules 3 and only some (or all) second modules 4 may comprise the other transmission side surface 43. Providing all modules 3, 4 with the other transmission side surface 43 has the additional benefit of ease of manufacturing, as these can be manufactured at least similarly or the same and flipped or turned when stacking. Since the other transmission side surface 43 is especially applicable to cases in which the antenna device 1 is directly above a base station, a signal strength needed for this transmission side surface 43 (or sensitivity for reception) can be reduced, such that not all modules 3, 4 need them, thus saving weight, costs and easing control and manufacturing of the antenna device 1.

FIG. 4c shows a detailed cross-sectional view of an alternative example of one module 4 comprised in an antenna device 1 according to the second or third embodiment of the present invention.

Herein, the module 4 comprises two Rotman lenses 24. Therein, the additional Rotman lens 24 for the other transmission side surface 43 is connected to hollow waveguides 21 connected to further coupling ports 22 as well as hollow waveguides 21 connected to the antenna elements 13 of the second end face 6.

Thereby, beam directionality can be further enhanced.

FIG. 4d shows a detailed cross-sectional view of another alternative example of multiple modules 3, 4, 46 comprised in an antenna device according to the second or third embodiment of the present invention.

As can be taken therefrom, in this example, the antenna device 1 comprises the first and second modules 3, 4, as well as a third module 46. Each of these modules 3, 4, 46 comprises a Rotman lens 24 in this example. Each of these modules 3, 4, 46 comprises respectively one transmission side surface 14, 16, 43.

Herein, the other transmission side surface 43 of the third module 46 is formed via antenna elements 13 connected to a Rotman lens 24.

Further, in this example, the antenna elements 13 are formed as halves in each module 3, 4, 46. For example, in FIG. 4d, the two top modules 4, 46 each comprise, on their second end face 6, one half of the antenna elements 13, i.e. one half of the hollowed-out portions forming these. In this case, a thickness of each of the modules 3, 4, 46 is set such that the distance between antenna elements 13 at least in thickness direction 20 is preferably N/2.

As will now be explained with reference to FIG. 5, the first and second modules 3, 4 of the first embodiment shown in FIG. 1 are arranged such that their coupling side-surfaces 23 are all formed on the fourth end face 8, and are thus all part of the same side-surface 12, namely a third side-surface 12 of the base body 2.

FIG. 5 shows a schematic diagram displaying components of the antenna device 1 according to the first embodiment of the present invention. FIG. 5 shows a perspective view different from that of FIG. 1 such that transmission side-surfaces 16 of the second modules 4 are visible. Further, FIG. 5 show the first modules 3 and the second modules 4 in a detailed view, as discussed above with regard to FIG. 4.

The antenna device 1 comprises a signal distribution network 30. In the present embodiment, the signal distribution network 30 is formed as a circuit board. The signal distribution network 30 (henceforth “network”) comprises a plurality of network ports 31. Each of the network ports 31 is connected to one coupling port 22 of all modules 3, 4.

Therefore, as shown in FIG. 5, the network 30 comprises nine columns of network ports 31 for the nine coupling ports 22 of each module 3, 4 as well as four rows corresponding to four first modules 3 and four rows corresponding to four second modules 4 (eight modules 3, 4 in total). Thus, in total, the network 30 comprises 72 network ports 31 for the 72 coupling ports 22 of all modules 3, 4.

Thereby, the antenna device 1 is capable of transmitting/receiving one or more signal beams 29 simultaneously. Furthermore, the signal beam(s) 29 can be controlled with respect to their directionality (and power) depending on feeding/receiving to/from the network ports 31, i.e. the coupling ports 22.

With reference to FIG. 6, further details concerning the network 30 will be explained. FIG. 6 shows a perspective view of details of the antenna device 1 according to the first embodiment of the present invention.

In FIG. 6, a base plate 40 is shown, on which the base body 2 is mounted. The network 30 is mounted on the base plate 40, but is shown separately herein for higher clarity.

Furthermore, FIG. 6 shows additional details concerning the network 30. The network 30 comprises a bidirectional frontend 32 (henceforth “frontend”). In this example, shown are two sets of five first modules 3 (two times five antenna elements on one transmission side-surface 16) and two sets of five second modules 4 (two times five antenna elements on the other transmission side-surface 14, not visible). In this example, the number of coupling ports 22 (indicated by the network ports 31) is equal to the number of antenna elements 13. As shown in FIG. 5, however, their numbers are not necessarily equal. For example, FIG. 5 shows nine coupling ports 22 and eight antenna elements 13 per module 3, 4.

Furthermore, the network 30 comprises a converter 34 configured to convert the transmitted/received signal. For example, the converter 34 converts in the present case between a 2 GHz supplied/received and processed by further electronics (“TX”, “RX”) to the frequency used for transmission/reception, for example the Ka frequency band.

The frontend 32 is connected bidirectionally, i.e. for transmission and reception, to the network ports 31. Thus, the frontend 32 of the present embodiment has ten channels, as indicated by arrows 33. In the case of multiple transmission side surfaces 14, 16, 43, the frontend 32 may have a multiple of ten channels (for example, with multiple Rotman lenses 24), or one additional channel for each additional coupling port 22 (see FIG. 4b) Further, as indicated in FIG. 6, by spacing the antenna elements 13, especially via the arrangement of the modules 3, 4, multiple matrix arrays of antenna elements 13 are formed. In addition, the two sets of five modules 3, 4 may be separated from one another, as indicated by their spacing in FIG. 6. Thereby, multiple beams 29 can be transmitted/received as well as their individual direction controlled. Further yet, by providing the two transmission side-surfaces 14, 16, the antenna device 1 is capable of receiving/transmitting in two opposing direction simultaneously, as indicated by shown beams 29.

The network 30 also comprises a control element 42, which controls switches 38 (described below).

With reference to FIG. 7, further details of the network 30 and the beam control will be explained. Therein, FIG. 7 shows a detailed view of a part of the antenna device 1 according to the first embodiment of the present invention shown in FIG. 6. In particular, FIG. 7 shows one second module 4, in cross-sectional view as in FIG. 4, with the Rotman lens 24 and hollow waveguides 21 visible. Furthermore, dashed lines within the Rotman lens 24 demonstrate wave propagation therein. FIG. 7 particularly shows a detail of the network 30 for one module 4, wherein the other modules 3, 4 (see FIG. 6) and channels 33 of the frontend 32 are omitted in FIG. 7 for ease of explanation.

The network 30 comprises, for each module 3, 4, i.e. for each channel 33, one frontend-line 37. The frontend 32 is connected to all coupling ports 22 of a single module 4 in common via one frontend-line 37 and via the network ports 31 of the signal distribution network 30. Each of the coupling ports 22 is connected to the frontend 32 via one respective switch 38 connected to the frontend-line 37 such that the number of switches 38, per module 4, corresponds to the number of coupling ports 22/network ports 31. Therefore, the signal distribution network 30 comprises a number of frontend-lines 37 corresponding to the total number of modules 4 (of all types), each one frontend-line 37 being connected to one module 4. The switch 38 is especially a microwave switch.

Furthermore, the network 30, particularly the frontend 32, comprises a variable phase-shift circuit 39 configured to phase-shift the signal between the network ports 31 of different modules 4 so as to control beam directionality and so as to control beam sectioning of transmitted/received beams. By introducing a phase-shift between the different modules 3, 4 (i.e. between different frontend-lines 37), the modules 3, 4 can be controlled to form beams 29 separate from one another, i.e. sectioned, or to together form one or more common beams 29 via interference. Furthermore, the aforementioned phase-shift between the different modules 3, 4 allows for controlling beam directionality preferably in elevation angle 47 (i.e. vertically).

Further, by controlling the switches 38, the appropriate coupling port 22 is chosen so as to appropriately select a beam directionality. Switching a different switch 38 to ON causes the beam 29 to swivel or pan with respect to a surface normal 44. In other words, the directionality of the beam 29 is thereby controlled with regard to its azimuth angle 48 (i.e. horizontally).

By combining control over the elevation angle 46 via the phase-shift circuit 39 and controlling the azimuth angle 48 via the switches 38, each beam 29 or sub-sections of the beam 29 can be directionally controlled in three dimensions.

Further, the aforementioned beam sectioning essentially generates (or receives correspondingly) separate beams 29. For instance, if N is the total number of all types of modules 3, 4, and each such beam section (or individual beam 29) is formed by two modules 3, 4, then the antenna device 1 can section the beam 29 into N/2 individual beam sections or beams 29. Each of these beam sections can then be further controlled in elevation 47 and/or azimuth angle 48.

With this, it is also possible to communicate with multiple receiver/transmitters such as multiple base stations.

Although in the shown example only one switch 38 is closed, multiple switches 38 may simultaneously be opened.

The frontend 32 also comprises a mixer 41, with which the TX/RX signals are modulated from a base band to a carrier frequency.

FIG. 8 shows a schematic diagram of the antenna device 1 according to the second or third embodiment of the present invention. In particular, FIG. 8 shows an antenna device 1 with a base body 2 comprising modules 3, 4 with three transmission side-surfaces 14, 16, 43.

Therein, the third transmission side-surface 43 is formed in common between the first modules 3 and the second modules 4 on their second end faces 6 described with respect to FIG. 2 and FIG. 3.

Furthermore, the antenna device 1 may comprise a cover circuit board 45. The cover circuit board 45 forms the antenna elements 13 in addition to the ends of the hollow waveguides 21. The antenna elements 13 of the foregoing embodiments may thus be formed only as open ends of the hollow waveguides 21 or as a combination of the open ends of the hollow waveguides 21 with the cover circuit board 45.

In addition or alternatively, the third transmission side-surface 43 may be defined by a third module, as described with respect to the first embodiment.

As denoted by reference numeral 100 in FIG. 8, the base plate 40 of the antenna device 1 may be attached to or may be a part of an outer surface of an aircraft or spacecraft, especially of a satellite 100 of the present invention comprising the antenna device 1.

In addition to the foregoing written explanations, it is explicitly referred to FIGS. 1 to 8, wherein the figures in detail show configuration examples of the invention.

### REFERENCE NUMERALS

1 Antenna device
2 base body
3 first module
4 second module
5 first end face
6 second end face
7 third end face
8 fourth end face
9 first side-surface
10 second side-surface
11 fourth side-surface
12 third side-surface
13 antenna element
14 transmission side-surface
15 non-transmission side-surface
16 transmission side-surface
17 plate
18 plate
19 plate
20 thickness direction (stacking direction)
21 hollow waveguide
22 coupling port
23 coupling side-surface
24 Rotman lens
25 height of double ridged hollow waveguide
26 total width of double ridged hollow waveguide
27 ridge-height of double ridged hollow waveguide
28 ridge-width of double ridged hollow waveguide
29 signal beam
30 signal distribution network
31 network port
32 bidirectional frontend
33 arrow
34 converter
35 shortest distance between two adjacent antenna elements of a single module
36 shortest distance between two adjacent antenna elements of two different modules of the same type
37 frontend-line
38 switch
39 variable phase-shift circuit
40 base plate
41 mixer
42 control element
43 transmission side-surface
44 surface normal
45 cover circuit board
46 third module
47 elevation angle
48 azimuth angle
100 satellite

1. An antenna device for transmission and reception of microwaves with controllable multi-beam directionality, comprising:
a base body, which comprises at least one plate-shaped module as a first type and at least one further plate-shaped module as a second type, the first module(s) and the second module(s) being stacked on top of one another and their end faces taken together defining side-surfaces of the base body, wherein;
each module comprises at least one transmission side-surface as an end face thereof,
each transmission side-surface of each module comprises a plurality of antenna elements,
the first module(s) and the second module(s) are arranged such that one transmission side-surface of the first module(s) is part of a first side-surface of the base body and one transmission side-surface of the second module(s) is part of a second side-surface of the base body, the first and second side-surfaces of the base body being different, and
each transmission side-surface of each module defines, via its antenna elements, an antenna array.

2. The antenna device according to claim 1, wherein a plurality of the antenna elements of each module are arranged in a line so as to define a row of antenna elements.

3. The antenna device according to claim 1, wherein each module further comprises a coupling side-surface as another end face thereof and wherein each coupling side-surface of each module comprises a plurality of coupling ports.

4. The antenna device according to claim 3, wherein the modules are arranged such that the coupling side-surfaces of all modules are part of a same third side-surface of the base body.

5. The antenna device according to claim 3, wherein each module comprises a plurality of hollow waveguides connecting the coupling side-surface with the transmission side-surface.

6. The antenna device according to claim 5, wherein each module comprises a beam-forming network connected to the hollow waveguides, the beam-forming network comprising at least one of a Ruze lens, a Rotman lens, a Luneberg lens and a Butler matrix.

7. The antenna device according to claim 6, wherein an electric path length of at least two hollow waveguides between the coupling side-surface and the transmission side-surface differs between one another.

8. The antenna device according to claim 3, further comprising a signal distribution network, the signal distribution network comprising a plurality of network ports, each network port being connected to one coupling port.

9. The antenna device according to claim 8, wherein the signal distribution network comprises at least one switch element respectively configured to switch at least one network port.

10. The antenna device according to claim 8, wherein the signal distribution network comprises a bidirectional frontend connected to the network ports and configured to phase-shift a signal between the network ports so as to control beam directionality of transmitted or receivable microwaves.

11. The antenna device according to claim 3, wherein the number of coupling ports and the number of antenna elements are not equal.

12. The antenna device according to claim 1, wherein a shortest distance between two antenna elements of one module and/or a shortest distance between two antenna elements of multiple modules of the same type is substantially λ/2.

13. The antenna device according to claim 1, further comprising at least one further plate-shaped module as a third or more type, wherein each type of module comprises a respective transmission side-surface, and all types of modules are arranged such that their transmission side-surfaces are part of different side-surfaces of the base body.

14. An aircraft or spacecraft, comprising at least one antenna device according to claim 1.

15. The antenna device according to claim 2, wherein the plurality of antenna elements define, in a case of at least two of at least one single type of module, columns of antenna elements so as to define an antenna matrix array.

16. The antenna device according to claim 3, wherein each module comprises a plurality of wave guides connecting the coupling ports with the antenna elements.

17. The antenna device according to claim 9, wherein the at least one switch element is configured to switch exactly one network port.

18. The antenna device according to claim 10, wherein the bidirectional frontend is configured to variably phase-shift the signal between the network ports.

19. The antenna device according to claim 10, wherein the bidirectional frontend is configured to phase-shift the signal between the network ports so as to control beam sectioning of transmitted or receivable microwaves.

20. A satellite, comprising at least one antenna device according to claim 1.
